(19) United States
(12) Patent Application Publication
(10) Pub. No.: US 2024/0391678 A1
(43) Pub. Date: Nov. 28, 2024

(54) FOIL CARTRIDGE, SUPPORT SLEEVE AND CARTRIDGE SYSTEM

(71) Applicant: medmix Switzerland AG, Haag (CH)

(72) Inventors: Tobias BODENMÜLLER, Haag (CH); Marcel RICHTER, Haag (CH); Richard LAVELANET, Haag (CH)

(21) Appl. No.: 18/580,836

(22) PCT Filed: Jul. 21, 2022
(86) PCT No.: PCT/EP2022/070474

§ 371 Date: Jan. 19, 2024

(30) Foreign Application Priority Data
Jul. 22, 2021 (DE) 20 2021 103 913.2

(51) Int. Cl. B65D 83/00; B05C 17/005; B65D 75/58

(52) U.S. Cl. CPC B65D 83/0072; B05C 17/00583; B65D 75/5883

(57) ABSTRACT

A foil cartridge fillable with at least one fluid includes a foil bag as a cartridge shell and a rigid head part. The head part includes an outlet opening for emptying the fluid of the foil cartridge and an external thread for fastening the foil cartridge to a support sleeve. The foil bag is fixed to the head part in the region of the external thread.

### CROSS-REFERENCE TO RELATED APPLICATION

This application is a U.S. National Stage Application of International Application No. PCT/EP2022/070474, filed Jul. 21, 2022, which claims priority to German Application No. 202021103913.2, filed Jul. 22, 2021, the contents of each of which are hereby incorporated by reference.

### BACKGROUND

### Technical Field

The disclosure relates to a foil cartridge fillable with at least one fluid including a foil bag as a cartridge shell and a rigid head part. The disclosure furthermore relates to a support sleeve for holding or supporting a foil cartridge according to the disclosure and to a cartridge system comprising at least one foil cartridge according to the disclosure, a support sleeve according to the disclosure, and a piston.

### Background Information

Cartridges are, for example, filled with sealants or adhesives and used with a gun-type one- or two-component mixing or dispensing system to dispense the material included therein. In some systems, such as the so-called side-by-side cartridge (dual cartridge), the mixing or dispensing system has a piston for each receiving unit of the cartridge filled with sealant or adhesive, the piston being configured to dispense the sealant or adhesive from the cartridge. So-called coaxial cartridges can also be used in which only one piston is used to dispense the material included therein, wherein an outer cartridge surrounds an inwardly disposed cartridge here.

### SUMMARY

In view of the growing demand for more sustainable apparatus, mixing or dispensing systems are now often configured as reusable systems so that only the cartridge has to be replaced when it has been completely emptied.

Furthermore, so-called foil cartridges are also increasingly being used for the cartridges to be replaced. Unlike conventional cartridges, which are made entirely of plastic, foil cartridges can be at least partly configured as a foil or film. In known foil cartridges, the cartridge wall that surrounds the cartridge chamber is configured as a film or foil and is connected to a rigid head part that, for example, includes plastic. This design has a variety of advantages. On the one hand, cartridges that have not yet been filled can be better stored and transported from the cartridge manufacturers to the manufacturers of the filling material (i.e. adhesives, sealants or similar) since the foil cartridges require significantly less space in the collapsed state. Only at the time of filling does the foil cartridge then expand to its final size that can be selected as desired.

On the other hand, foil cartridges are also significantly lighter than conventional cartridges composed of plastic. This means that the foil cartridges are significantly smaller and lighter before and after use in comparison with conventional cartridges. The disposal costs can thus also be significantly reduced.

In any case, the ecological footprint of a foil cartridge is significantly better than that of conventional cartridges made of plastic (e.g. by injection molding).

Compared to solid cartridges, foil cartridges have no inherent stability. Thus, foil cartridges will collapse during use if they were not further supported. Therefore, (reusable) support sleeves are provided in known systems and so-to-say serve as a skeleton for the foil cartridge and give it the required stability.

Such support sleeves are usually made of metal and/or plastic to ensure that they can be used multiple times. To hold the foil cartridge, the head part of the foil cartridge is usually clamped at a front end of the support sleeve in known systems so that the piston can press against the flexible cartridge wall from behind in order thereby to empty it.

For this reason, it is an object of the disclosure to provide a cartridge by which the replacement or the fastening of the foil cartridge to the support sleeve is simplified.

This object is satisfied by embodiments of the foil cartridge, the support sleeve and the cartridge system having the features disclosed herein.

The disclosure in particular provides a foil cartridge fillable with at least one fluid, wherein the foil cartridge includes a foil bag as a cartridge shell and a rigid head part. The head part comprises at least one outlet opening for emptying the fluid of the foil cartridge and at least one external thread for fastening the foil cartridge to a support sleeve, wherein the foil bag is fixed to the head part in the region of the external thread.

Advantageous embodiments of the invention can be seen from the description, and from the drawings.

According to one embodiment, the foil bag is fixed to an outer side of the head part. The foil bag can in this respect overlap the head part in a certain region so that it can be molded, adhesively bonded or otherwise fixed to the head part.

According to one embodiment, the foil bag is fastened to the head part such that the foil bag envelops the external thread or contacts the external thread in a form-fitting manner. This means that the foil bag can be tensioned so that the foil bag indeed lies above the external thread, but fits snugly against it such that the foil cartridge is not prevented from being able to be screwed to a support sleeve.

According to an alternative embodiment, the foil bag is fixed to an inner side of the head part. Equally, it is also possible that the head part is equipped such that the foil bag is fastened to an inner side of the head part.

According to one embodiment, the foil bag is adhesively bonded to the head part.

According to one embodiment, the head part is molded to the foil bag. In other words, the foil bag can be injection-molded to the head part, regardless of whether it is to be fixed to the outer side or inner side of the head part.

In principle, the rigid head part can be connected to the flexible foil bag by gluing, shrinking or welding. A mechanical connection by means of a clip or a clamp—with or without a ring—is also conceivable.

According to one embodiment, the foil bag has at least one coating at an inner side and/or at an outer side. For example, it can be advantageous if the foil bag has a non-stick coating at the inside to be able to empty the foil bag as easily as possible during use. It can also be possible that coatings are required so that the contents of the foil bag do not react with the materials of the foil bag itself.

According to one embodiment, the foil bag is formed from at least two layers, in particular a plurality of layers, in particular an inner layer and an outer layer. It should be noted here that the inner layer is the innermost layer of the foil bag and the outer layer is the outermost layer of the foil bag. If further layers are arranged therebetween, they are each intermediate layers.

According to one embodiment, the at least two layers are formed from different materials. Thus, the foil bag can be optimally adapted for its subsequent use.

According to one embodiment, the layers each have a thickness between 4 and 100 μm.

According to one embodiment, the at least two layers have different thicknesses. The exact thickness of each layer can vary depending on the area of application and can be suitably selected.

According to one embodiment, at least one layer of the foil bag includes aluminum.

According to one embodiment, the at least two layers are connected to one another by at least one composite film. All the layers present can in particular be connected to one another by a composite film.

According to one embodiment, the foil bag has a third layer that is arranged between the inner layer and the outer layer, and wherein in particular the third layer comprises aluminum.

To minimize the permeation, in particular the oxygen permeation and the water vapor permeation of the foil bag, the foil bag can have a further layer that is in particular arranged between the inner layer and the outer layer and that comprises ethylene-vinyl alcohol copolymer (EVOH). This layer, which comprises or includes the ethylene-vinyl alcohol copolymer, can be arranged between the inner layer and the outer layer. The layer comprising or including ethylene-vinyl alcohol copolymer is preferably arranged directly next to the outer layer and/or directly next to the inner layer.

According to one embodiment, the outer layer of the foil bag is made of the same material as the rigid head part. The outer layer can hereby be easily connected to the rigid front part by injection molding.

According to a further embodiment, the inner layer of the foil bag has a plastic, in particular a thermoplastic. The recyclability of the foil bag is hereby improved while simultaneously simplifying the production of the foil bag.

According to one embodiment, the inner layer of the foil bag has the same material as the rigid head part. The inner layer and the outer layer of the foil bag preferably have the same material as the rigid head part.

According to a further embodiment, the inner layer of the foil bag is made of the same material as a part of the rigid head part brought into connection with the foil bag.

The foil bag can hereby be connected even more easily to the rigid head part by injection molding.

According to one embodiment, the inner layer has a Shore D hardness between 40 and 99, in particular between 40 and 60.

The inner layer of the foil bag can, for example, be made of polyethylene, polypropylene, polyamide, polyethylene terephthalate, or polybutylene terephthalate. The inner layer can, for example, have polyamide in the form of PA6 or PA-66. Polyamide has the advantage that it has a high mechanical stability and this stability can be increased even further by stretching. Polyethylene terephthalate (PET), on the other hand, is inexpensive and has a good chemical resistance.

According to a further embodiment, the outer layer of the foil bag has a plastic, in particular a thermoplastic.

According to one embodiment, the outer layer has a Shore D hardness between 40 and 99, in particular between 40 and 60.

The outer layer of the foil bag is advantageously made of polyethylene, polypropylene, polyamide, polyethylene terephthalate, or polybutylene terephthalate. The outer layer can, for example, have polyamide in the form of PA-6 or PA-66.

According to an even further embodiment, the rigid head part has a plastic, in particular a thermoplastic.

The rigid head part in particular has a Shore D hardness between 40 and 99, in particular between 40 and 60.

The rigid head part can preferably be made of polyethylene, polypropylene, polyamide, polyethylene terephthalate, or polybutylene terephthalate. The rigid front part can, for example, have polyamide in the form of PA-6 or PA-66. Polyamide has the advantage that it has a high mechanical stability and is thus well suited for the rigid front part. Polyethylene terephthalate (PET) could also be used for the rigid front part. PET is namely easy to process and has a high chemical resistance.

According to one embodiment, the rigid head part is made of a high density polyethylene (HDPE), wherein a high density polyethylene (HDPE) has a density in the range from 930 kg/m³ to 970 kg/m³.

According to one embodiment, the foil bag is sealed by a weld seam at a rear end remote from the rigid head part. The shape of the rear end can be dome-shaped or conical, for example. The rear end of the foil bag can generally taper continuously. Alternatively thereto, the foil bag can have a rear side that is substantially planar.

According to one embodiment, the foil bag is sealed by a clip at a rear end remote from the rigid head part. Such a clip can, for example, be made of plastic.

According to one embodiment, the foil bag is sealed by an adhesive at a rear end remote from the rigid head part.

According to an embodiment, the foil bag is formed as stiff in a direction of traction. The foil bag thus has a defined length in a filled state and can thereby be securely inserted into a cartridge system.

The foil bag advantageously withstands a tensile load of 50N to 80N in an axial direction. In other words, the foil bag has a tensile strength of at least 50N in the axial direction. The foil bag is hereby prevented from tearing due to a tensile load.

According to one embodiment, the foil bag has a puncture resistance between 10 N and 20 N. The puncture resistance can be determined based on the standard DIN EN 14477, r=0.4 mm for pointed objects or based on the standard ASTM F 1306 for blunt objects. The puncture resistance can be in the range from 10 N to 20 N for at least one of the two test standards. The puncture resistance for both test standards is preferably in the range from 10 N to 20 N.

The inner layer preferably has a greater thickness than the outer layer. The inner layer can, for example, have more than 1.5 times the thickness of the outer layer. The inner layer preferably has a thickness that is more than twice the thickness of the outer layer.

According to one embodiment, the inner layer has a minimum thickness of 50 μm to 90 μm. The inner layer preferably has a minimum thickness of 55 μm to 80 μm. The minimum thickness of the inner layer can be selected depending on the material used for the inner layer and on the volume of the filling material.

According to one embodiment, the foil bag has a total material thickness between 80 μm and 150 μm. The film thickness can be determined in accordance with DIN EN ISO 4593. The foil bag preferably has a total material thickness between 110 μm and 150 μm.

According to one embodiment, the foil bag can have a total weight per unit area between 100 g/m² and 170 g/m². The total weight per unit area can be determined in accordance with DIN EN ISO 2286-2. The foil bag preferably has a total weight per unit area between 120 g/m² and 150 g/m².

According to one embodiment, the foil bag has a water vapor permeation of at most 0.3 g/(m²×d), in particular of at most 0.2 g/(m²×d). The water vapor permeation is measured using the standard ISO 15106-3 (38° C./90% r.h.). The foil bag preferably has a water vapor permeation that is in the no longer measurable lower range, i.e. close to 0 g/(m²×d), using the standard ISO 15106-3 (38° C./90% r.h.).

According to a further embodiment, the foil bag has an oxygen permeation of at most 0.3 cm³/(m²×bar×d), in particular of at most 0.2 cm³/(m²×bar×d). Oxygen permeation is measured using the standard ASTM D3985 (23° C./90% r.h.). The foil bag preferably has an oxygen permeation that is in the no longer measurable lower range, i.e. close to 0 cm³/(m²×bar×d), using the standard ASTM D3985 (23° C./90% r.h.).

According to one embodiment, the foil bag has a wall thickness or film thickness of at least 60 μm. The foil bag preferably has a wall thickness or film thickness of at least 80 μm. It can hereby be ensured that the foil bag has sufficient mechanical properties.

According to one embodiment, each of the layers of the foil bag has a thickness of at least 4 μm, in particular at least 5 μm. However, any possibly present bonding agents between the layers, which serve to connect the layers to one another, are not regarded as a layer. The bonding agents possibly present between the layers can have a thickness of less than 5 μm. Bonding agents are preferably provided between layers of different materials that have a thickness of 5 μm or less.

According to one embodiment, a bonding agent is arranged at least between two layers of the foil bag and connects the two layers to one another. If the two layers consist of different materials, a bonding agent is advantageous since layers of different materials are otherwise more difficult to join.

According to one embodiment, the bonding agent has a thickness of 1 μm to 5 μm. The thickness of the bonding agent layer should not be less than 1 μm since otherwise no or too little bonding agent could be applied in some places due to tolerance fluctuations. It has also been found that a bonding agent thickness of more than 5 μm does not cause an additional improvement in the adhesion between the layers of the foil bag.

In this connection, it should be mentioned that each of the layers of the foil bag can have a thickness between 4 μm and 100 μm. In particular, each of the layers of the foil bag can have a thickness between 5 μm and 70 μm. According to a specific embodiment, all the layers of the foil bag except for the inner layer have a thickness between 5 μm and 30 μm.

According to one embodiment, the at least one foil bag has a substantially cylindrical outer shape. Alternatively or additionally, the at least one foil bag has a weld seam in the axial direction. The weld seam can be designed as a fin seam that is often referred to as a “fin seal”. Alternatively, the weld seam can also be configured as an overlap seam that is often referred to as an “overlap seal”.

According to one embodiment, the outer layer of the foil bag is areally connected to an inner wall of the front part. In other words, the outer layer of the foil bag is not only connected to the inner wall of the front part by a line contact, but over a width of at least 2 mm.

For applications in the field of medical technology or for smaller jobs in the construction sector, it can be advantageous if the foil bag has a volume in the range from 50 ml to 750 ml. A foil bag preferably has 100 ml, 200 ml or 500 ml.

On the other hand, for larger jobs, in particular in the construction sector, it can be advantageous if the foil bag has a volume in the range from 750 ml to 5000 ml. For example, the at least one foil bag can have a volume of 1000 ml, 1250 ml, 1500 ml, 2500 ml or 4000 ml.

To avoid mixing up the cartridges and to make it easy to find out what the foil bag has been filled with, a label for the contents of the foil bag or the cartridge can be applied at the outer side of the foil bag. This label is preferably applied to the foil bag shortly before the foil bag is filled or after the foil bag has been filled. Errors can thus be minimized when applying the label.

According to one embodiment, the head part has one or more stiffening ribs at a side facing away from the foil bag. The ribs can, for example, extend over the side of the rigid head part facing away from the foil bag. The ribs can thus be used to stabilize the region around the outlet opening to better absorb forces that are transmitted to the head part during the dispensing and to prevent a deformation of the head part.

In this connection, it should be mentioned that the one or more stiffening ribs can be arranged in a peripheral direction.

Alternatively or additionally, the plurality of stiffening ribs can also extend in a radial direction, starting from a center axis of the foil cartridge.

In any case, the stiffening ribs can increase the stability of the head part so that the head part can withstand the pressures that arise when the fluid is pressed out of the head part.

According to one embodiment, the head part is substantially dome-shaped. Advantageously, the stiffening ribs can be arranged on the dome. A dome-shaped design has proven to be particularly advantageous for both visual and haptic reasons. Furthermore, the foil cartridge can be emptied in the best possible way by such a design.

According to one embodiment, the head part has at least one wing that is in particular arranged at the dome. Such a wing can serve as a handle for the foil cartridge so that a user can easily screw the foil bag on and off the support sleeve.

The wing can be larger than at least one of the one or more stiffening ribs. It is thereby ensured that the user can actuate the wings without the stiffening ribs being obtrusive.

According to a further embodiment, the wing has a height that is greater than a height of at least one of the one or more stiffening ribs. This means that the wing can be higher than the stiffening ribs so that the user can grip it easily.

According to one embodiment, the wing has at least substantially the same thickness, in particular exactly the same thickness, as the one or more stiffening ribs. In this connection, the term “substantially the same” is to be understood as the thickness of the wing not differing by more than +/−5% from the thickness of the stiffening ribs.

In particular, a design with exactly the same thicknesses of wings and stiffening ribs has proven to be particularly simple and cost-effective to manufacture.

According to one embodiment, the head part has a web region that is arranged in the peripheral direction and that extends over a front end of the foil bag facing the head part. Such a web can, for example, serve as a stop for a support sleeve when these two parts are connected to one another.

According to a further embodiment, the head part has at least one alignment element that is configured to align the head part with respect to a support sleeve. The alignment element can be designed in different ways as long as it is capable of aligning the head part at a support sleeve. For example, it can represent a marking, a projection or a recess or similar that must be brought to a certain position at the support sleeve to align the head part properly. Further designs are generally also possible for the alignment element.

The alignment element can furthermore be provided radially outwardly at the head part. With such a position of the alignment element at the head part, the alignment element is arranged such that, on the insertion of the foil cartridge into a support sleeve, the alignment element is provided as close as possible to the support sleeve to facilitate the alignment of the head part.

In this connection, provision can also be made that the alignment element is arranged at the web region.

In particular, it is also possible that the alignment element is arranged at the end face, i.e. in the direction of the outlet at the head part. Such an alignment can make the handling easier for a user since the user can easily see the alignment element to align the head part at a support sleeve.

According to a further embodiment, the alignment element is arranged in the region of at least one radial stiffening rib.

According to an alternative embodiment, the alignment element is arranged in the region of at least one wing, preferably arranged between two wings.

According to a further embodiment, the head part has at least one alignment projection that is configured to align the head part at a predetermined angle with respect to a support sleeve.

For this purpose, the alignment projection can be arranged at a side of the head part facing the foil bag so that it is oriented in the direction of the support sleeve even when the foil cartridge is connected to a support sleeve.

Furthermore, it would also be conceivable that the alignment projection is arranged at the web region. Accordingly, the alignment projection would be arranged at the radially outer region of the head part, where the support sleeve also frequently comes into contact with the head part.

According to one embodiment, the outlet opening of the head part has a substantially constant cross-section.

According to a further embodiment, the outlet opening has an internal thread to which an outlet nozzle can be fastened.

According to an alternative embodiment, the outlet opening has an external thread to which an outlet nozzle can be fastened.

In principle, outlet nozzles can serve for a better and more precise metering of the fluid that is present in the cartridge.

According to a further embodiment, in a filled state of the foil bag, the outlet opening is sealed by a membrane that can in particular be pierced by the outlet nozzle. The sealing of the outlet opening mainly serves to ensure that the foil cartridge can be stored and transported without leaking. In particular, it is also possible that the fluid in the cartridge reacts with oxygen so that it must be stored in a protective atmosphere. By sealing the outlet opening, a reaction with oxygen can be avoided until use.

According to one embodiment, the outlet opening is arranged at a side of the dome of the head part facing away from the foil bag.

According to a further embodiment, the head part has a run-out region in which the outlet opening is formed and which extends along a center axis of the foil cartridge. In other words, the outlet opening can be designed in a region of the head part that projects along the center axis. The metering of the fluid can hereby be optimized. Furthermore, it can thereby also be made easier to fasten an additional outlet nozzle to the head part.

The run-out region can be substantially tubular and can at least regionally have a wall thickness between 0.5 and 1.5 mm. A good compromise between sufficient stability and material costs is hereby achieved.

The run-out region can furthermore have a length between 5 mm and 40 mm, in particular between 20 and 30 mm. The run-out region should be selected as short as possible to be able to completely empty the foil bag, but can still offer sufficient length in order, for example, to be able to fasten an outlet nozzle thereto.

The disclosure furthermore provides a support sleeve for holding or supporting a foil cartridge according to the disclosure, wherein the support sleeve can furthermore have an internal thread that corresponds to the external thread of the foil cartridge.

According to one embodiment, the support sleeve is formed from metal, in particular aluminum, and/or from plastic. Such materials enable a relatively fast and cost-effective production, wherein the desired rigidity of the support sleeve can simultaneously be achieved.

According to one embodiment, the support sleeve is formed in one piece.

According to an alternative embodiment, the support sleeve is formed in multiple parts. For example, a front and a rear part can be produced independently of one another and can only be joined together at a later point in time to form the support sleeve.

Here, it is possible that the support sleeve has at least one connection point, in particular a plurality of connection points, to connect the various parts of the support sleeve to one another.

The at least one connection point can be configured as a thread, as a bayonet connection or as a click closure. Thus, the various parts of the support sleeve can be releasably connected to one another.

According to one embodiment, the support sleeve comprises an inner sleeve and an outer sleeve. The inner sleeve can, for example, serve to hold the outer sleeve. Furthermore, the foil cartridge can be better protected by such a design.

According to one embodiment, the inner sleeve is movably, in particular slidingly, arranged in the outer sleeve. It can, for example, be possible that the outer sleeve is connected to the head part, while the inner sleeve only serves to protect the foil cartridge.

According to a further embodiment, the internal thread is a multi-start thread, in particular a two-start thread.

According to an even further embodiment, the support sleeve further comprises at least one alignment member that is configured to align the support sleeve with respect to the head part at a predetermined angle.

The alignment member can further be configured to cooperate with an alignment element.

This means that the alignment member can, for example, be configured such that it corresponds to or cooperates with the alignment element of the foil cartridge to align the head part and support sleeve with one another.

According to a further embodiment, the support sleeve comprises an alignment recess that is configured to align the support sleeve at a predetermined angle to the head part. The alignment recess can act in a supporting manner with respect to the alignment member. Furthermore, the alignment recess can also be configured such that it fixes the support sleeve relative to the head part when they are aligned accordingly.

According to an even further embodiment, the alignment recess is configured to cooperate with the alignment projection of the head part. This means that the alignment recess can be configured such that the alignment projection of the head part can engage or penetrate into the alignment recess of the support sleeve in order to align the support sleeve relative to the head part or, if necessary, also to fix it.

Furthermore, provision can also be made that the alignment recess comprises a holding projection that is configured in such a manner to fix the head part to the support sleeve in the peripheral direction. This holding projection can, for example, be configured and positioned such that, with a desired alignment of the head part relative to the support sleeve, the alignment projection of the head part is radially held and thus fixed by the holding projection.

In a further embodiment, the support sleeve furthermore comprises at least one vent hole that is arranged in a region adjoining the internal thread. For example, air that is inside the support sleeve can escape through the at least one vent hole when a piston is moved in the direction of the head part of the foil cartridge.

Furthermore, in some embodiments, the support sleeve can also comprise, in the region of the internal thread, a stop collar that is configured to provide a stop surface for a piston.

In this respect, it is also conceivable that the stop collar extends at a peripheral side around an inner surface of the support sleeve (100).

The disclosure furthermore provides a cartridge system comprising at least one foil cartridge according to the disclosure, a support sleeve according to the disclosure, and a piston, wherein the piston and the foil cartridge are arranged in a receiving region of the support sleeve and wherein the foil cartridge is screwed via its external thread to the internal thread of the support sleeve so that a part of the support sleeve covers a part of the head part of the foil cartridge. The support sleeve furthermore comprises at least one radial pin that is arranged at an end of the support sleeve facing away from the head part of the foil cartridge to fasten, in particular releasably fasten, the support sleeve to a dispensing system.

According to one embodiment, the at least one radial pin is mushroom-shaped. The radial pin can in particular be mushroom-shaped in a side view. Radial pins having a head part and a cylindrical part can, for example, be advantageous if the support sleeve is to be fixed to a dispensing system since the guidance of the radial pin in a corresponding recess is optimized by a special mushroom-shaped design.

In this connection, it is also possible that the radial pin is configured to cooperate with corresponding counter-elements, in particular recesses, at the dispensing system so that the support sleeve is fixedly fastened to the dispensing system.

According to a further embodiment, the cartridge system further comprises a protective ring that is configured to be fastened to the support sleeve. The protective ring protects against an accidental triggering of a release button or a lever of a dispensing apparatus. For this purpose, the protective ring can be moved under a trigger of a dispenser, i.e. a dispensing apparatus, so that the release button or the lever cannot be moved in the direction of the dispensing apparatus.

Alternatively, it can, however, also be possible that the trigger is brought under the protective ring to be able to generate a constant release of the trigger and thus a constant dispensing of material. For this purpose, the protective ring can, for example, have one or more protrusions under which the trigger can be moved.

In the case of a plurality of protrusions, they can have different heights that correspond to different trigger positions. Different trigger positions can here correspond to different dispensing speeds or dispensing pressures, for example.

It is also possible that the protective ring is axially movably arranged at the support sleeve to thus make it possible to bring the protective ring above or below the trigger or to move it away therefrom.

Furthermore, provision can also be made that the protective ring is radially rotatably arranged at the support sleeve to be able to rotate it in the peripheral direction and thus to bring it into different positions. This can, for example, be advantageous if the protective ring has various protrusions. Due to the radial rotatability, the protective ring can namely be easily rotated into the desired position relative to the trigger.

The protective ring can further comprise at least one support by means of which the support sleeve can be held. This has the advantage, for example, that the support sleeve can be held in an at least substantially horizontal position by the support of the protective ring so that an unintentional running out of material from the outlet opening can be avoided.

According to a further embodiment, the protective ring can, as already mentioned above, have at least one protrusion that is configured to cooperate with a trigger.

Furthermore, provision can also be made that the protective ring has a plurality of protrusions that in particular have different heights, wherein the protrusions are configured to cooperate with the trigger.

According to an even further embodiment, the piston can have a peripheral-side ring projection that is configured to receive the compressed foil bag. The ring projection can, for example, serve to receive those parts of the foil bag that have already been emptied so that the foil bag can ideally be emptied completely, or at least almost completely.

Furthermore, provision can also be made that the piston further has a substantially dome-shaped center part that is configured to compress the foil bag in the direction of the head part. The head part can here have a complementary shape to the piston. It has been shown that foil cartridges with dome-shaped pistons or head parts can be emptied better so that less residual material remains within the foil bag. Accordingly, a dome-shaped design can contribute to a better emptying of the foil cartridge.

The disclosure furthermore relates to a dispensing apparatus comprising a cartridge system according to the disclosure, further comprising a trigger for triggering an axial movement of the piston and a protective ring that is configured to avoid a release of the trigger and/or to ensure a constant release of the trigger and/or to keep the dispensing apparatus in an at least substantially horizontal position to avoid a running out of material when the trigger is not released.

### BRIEF DESCRIPTION OF THE DRAWINGS

The disclosure will be described with reference to purely exemplary embodiments and to the enclosed drawings in the following. There are shown:

FIG. 1 illustrates a perspective view of a foil cartridge according to the disclosure;

FIG. 2 illustrates a lower view of the foil cartridge of FIG. 1;

FIG. 3 illustrates a plan view of the foil cartridge of FIG. 1;

FIGS. 4 and 5 illustrate side views of the head part;

FIG. 6 illustrates a perspective view of the head part;

FIG. 7 illustrates a sectional representation of the head part;

FIGS. 8 and 9 illustrate side views of the foil cartridge according to the disclosure;

FIGS. 10A and 10B illustrate perspective views of a further embodiment of the head part;

FIGS. 11A, 11B and 11C illustrate detailed views of the connection between the head part and the foil cartridge;

FIGS. 12A, 12B and 12C illustrate a sectional representation of a piston within the support sleeve;

FIG. 13 illustrates a perspective view of a support sleeve according to the disclosure;

FIGS. 14 and 15 illustrate side views of the support sleeve of FIG. 13;

FIG. 16 illustrates a lower view of the support sleeve of FIG. 13;

FIG. 17 illustrates a plan view of the support sleeve of FIG. 13;

FIGS. 18A, 18B and 18C illustrate perspective views of the protective ring; and

FIGS. 19A and 19B illustrate sectional representations of the piston and of the piston within a support sleeve in the region of the head part of the foil cartridge.

### DETAILED DESCRIPTION

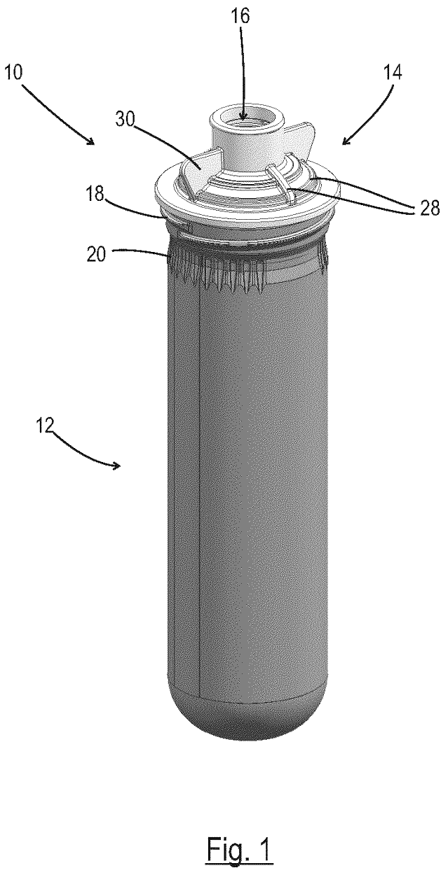

FIG. 1 shows a foil cartridge 10 according to the disclosure that can be filled with at least one fluid. The foil cartridge 10 comprises a foil bag 12 as a cartridge shell and furthermore comprises a rigid head part 14 that is shown at the top in the Figure. The head part 14 has an outlet opening 16 through which the fluid can flow when emptying the foil cartridge 10. Furthermore, the head part 14 comprises an external thread 18 that is configured to cooperate with a corresponding internal thread 102 of a support sleeve 100 to thereby fasten the foil cartridge 10 to the support sleeve 100.

The foil bag 12 can be fastened to the head part 14 in two different ways. On the one hand, it is possible that the foil bag 12 encloses the head part 14 from the outside so that a part of the foil bag 12 contacts the external thread 18 in a form-fitting manner and so-to-say envelops it (see FIG. 1). On the other hand, it is generally also possible that the foil bag 12 contacts an inner surface (not shown) of the head part 14 from the inside and is adhesively bonded or molded to the head part 14 there, for example.

Irrespective of whether the foil bag 12 is fastened to the outside or inside of the head part 14, various methods for fastening are conceivable. The foil bag 12 can therefore either be adhesively bonded or molded to the head part 14. Other fastening methods are also conceivable.

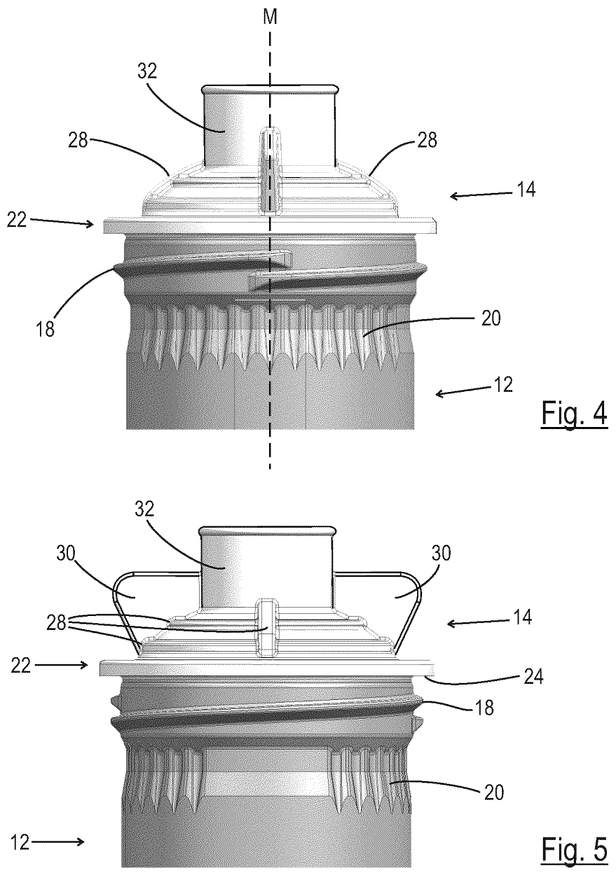

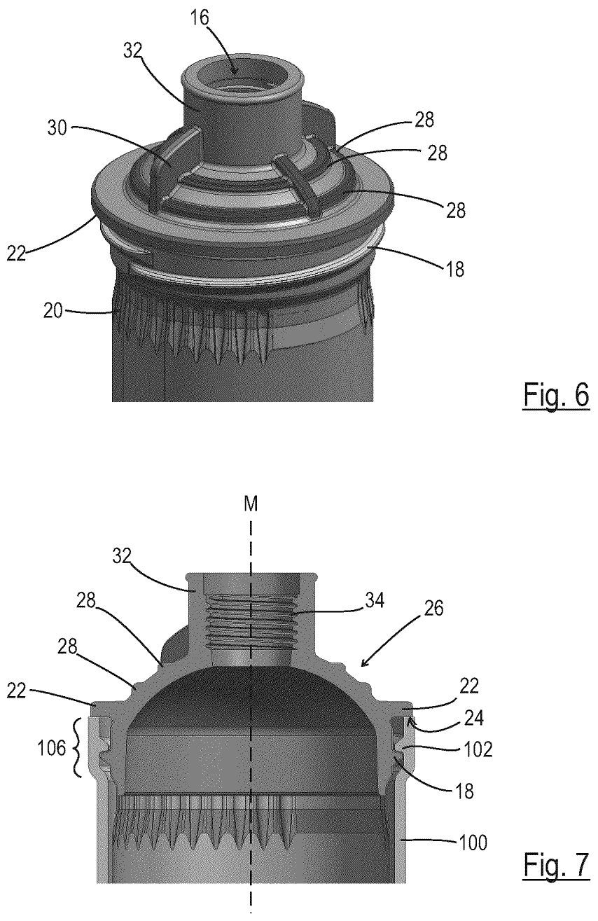

In FIGS. 1 and 4 to 7, it can in particular also be recognized that the foil bag 12 forms folds 20 at that region at which it is fastened to the head part 14. This is often a sign—particularly in a foil bag 12 that is fastened at the outside above the external thread 18—that the foil bag 12 is tensioned in this region to achieve a good sealing between the foil bag 12 and the head part 14.

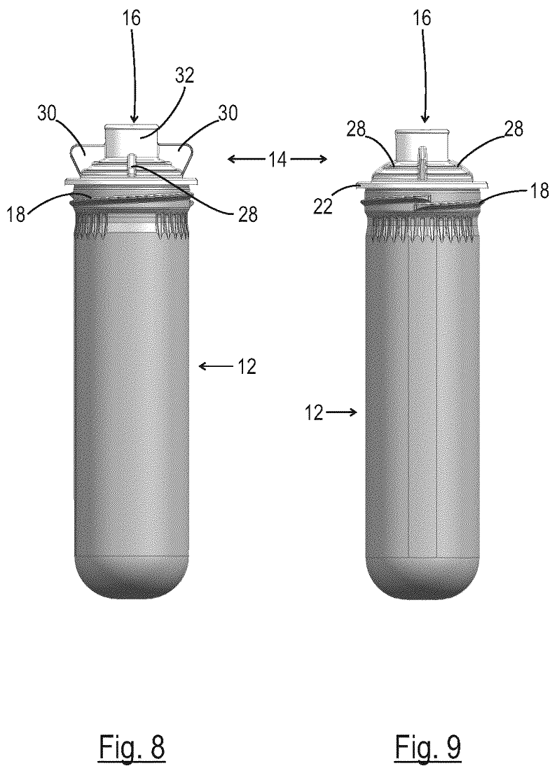

As can be seen in FIGS. 1, 8 and 9, the foil bag 12 substantially has a cylindrical shape. In this connection, it should be mentioned that the Figures show the foil bag in an expanded state—i.e. in a filled state. Due to its flexibility, the foil bag 12 can be folded or compressed in an emptied state and can thus be made considerably smaller. This has proven to be particularly advantageous for the storage and transport of empty foil cartridges 10.

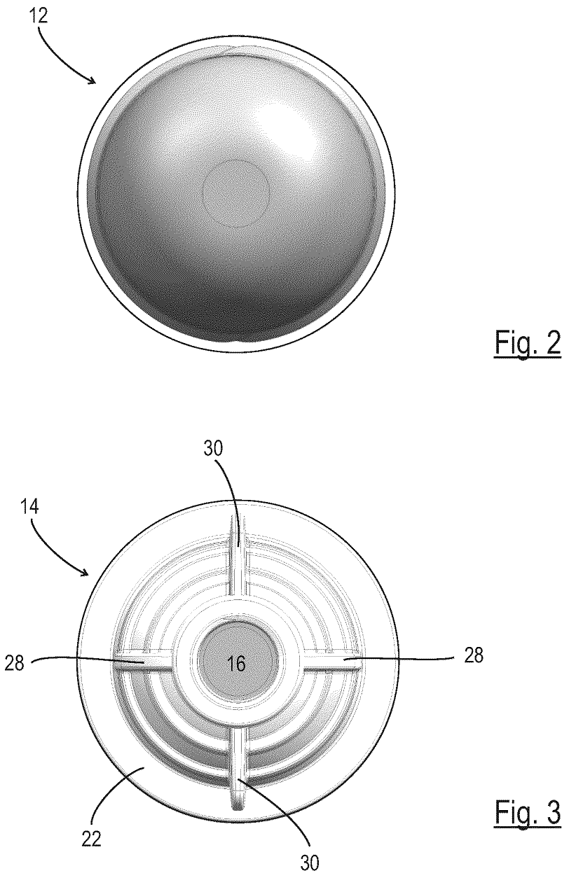

At its lower side (from the view of FIG. 1), the foil bag 12 can either be formed in one piece (see in particular the bottom view in FIG. 2) or can also be sealed by a seam, an adhesive joint, a clip or similar. This can be freely selected depending on the area of application and preferences.

In this connection, it should also be mentioned that the foil bag 12 can also have at least one seam, along which it is sealed, along its longitudinal axis M.

It is furthermore possible that the foil bag 12 is formed from two or more layers, in particular an outer layer and an inner layer, that are connected to one another by a composite film or a bonding agent. However, this is not shown further in the Figures since it is already known how multilayer foil bags 12 can be produced.

The length and the diameter of the foil bag 12 (and thus indirectly also of the head part 14) can be suitably selected depending on the application. There are basically no limits here.

In the following, the head part 14, which is shown in detail in FIGS. 3 to 7, will be discussed in more detail.

The head part 14 is made of a rigid material such as plastic and/or metal.

As already mentioned above, the head part 14 has, in the region at which it is connected to the foil bag 12, an external thread 18 that serves to fix the foil cartridge 10 to an internal thread of a support sleeve 100. The support sleeve 100 is discussed in more detail below. The external thread 18 can be configured as a multi-start thread, in particular as a two-start thread.

Above the external thread 18, the head part 14 furthermore has a web region 22 that extends around the entire head part 14 once in the peripheral direction. The web region 22 increases the diameter of the head part 14 to such an extent that it projects beyond the external thread 18 and thus serves as a stop 24 when fastening the foil cartridge 10 to the support sleeve 100. This is clearly recognizable in FIG. 7.

Furthermore, the head part 14 has a dome-shaped bulge 26 that is formed at a side of the head part 14 facing away from the foil bag 12. Since comparatively high pressures can act on the head part 14 when emptying the foil cartridge 10, a dome-shaped design has proven to be advantageous to be able to distribute the resulting pressure uniformly over the surface of the head part 14. Furthermore, the foil bag 12 can be emptied more easily overall by such a design since the fluid present therein thus always flows in the direction of the outlet opening 16 when pressure is exerted on the foil cartridge 10 from behind.

A plurality of stiffening ribs 28 are formed, in particular in the region of the dome 26, to further reinforce the head part 14. The stiffening ribs 28 can be arranged both in the peripheral direction and radially, as can in particular be recognized in FIGS. 1, 3 and 6. In any case, the stiffening ribs 28 serve to absorb and better distribute the pressure acting on the head part 14.

In the radial direction, starting from the outlet opening 16, two wings 30 are furthermore arranged that are configured to be actuated by a user to screw the foil cartridge 10 to the support sleeve 100 or to remove it from the support sleeve 100. The wings 30 generally have a greater height, in particular a greater surface area, than the radially arranged stiffening ribs 28, for example. The wings 30 thereby project further starting from the head part 14 or the dome 26 so that a user can easily grasp and actuate the wings 30.

In some embodiments, however, the wings 30 have the same or substantially the same thickness as the stiffening ribs 28. This means that the thicknesses of the wings 30 and the stiffening ribs 28 do not differ from one another by more than 5%. Such a design has proven to be particularly advantageous in terms of an efficient and cost-effective production.

The exact number of wings 30 and stiffening ribs 28 can be freely selected as required. Thus, with foil cartridges 10 having a larger total volume, it is, for example, possible that the head part 14 has more stiffening ribs 28 than a foil cartridge 10 having a smaller volume.

Furthermore, a run-out region 32 is formed in the head part 14 and extends along a center axis M of the foil cartridge 10. This run-out region 32 has an internal thread 34 (see FIG. 7) to which, for example, an outlet nozzle (not shown) can be fastened to ensure a precise metering of the fluid. Equally, it would also be possible that the run-out region 32 has an external thread to which such a nozzle can be fastened.

The size or height of the run-out region 32 can be selected as desired and can accordingly be suitably designed depending on the region of application. Here, too, it can again be possible that larger outlet nozzles 10 should be fastened to larger foil cartridges 10 and can possibly require a longer thread than for smaller designs.

In the embodiment shown, the run-out region 32 extends in parallel with the center axis M. In principle, however, it is also possible that the run-out region 32 and thus also the outlet opening 16 are not centrally arranged at the head part 14, but at an angle to the center axis M. This can in particular be advantageous if the foil cartridge 10 is to be used in dispensing systems that are, for example, suitable for reaching into corners and angles.

The wall thickness of the run-out region 32 can likewise vary or be freely selected. In most embodiments, however, it is in a range between 0.5 and 1.5 mm.

Furthermore, it is also possible that the run-out region 32 or the outlet opening 16 is sealed by a membrane (not shown) for the storage or transport of the foil cartridges 10, which membrane is then pierced as required—for example by attaching an outlet nozzle—and thus opened.

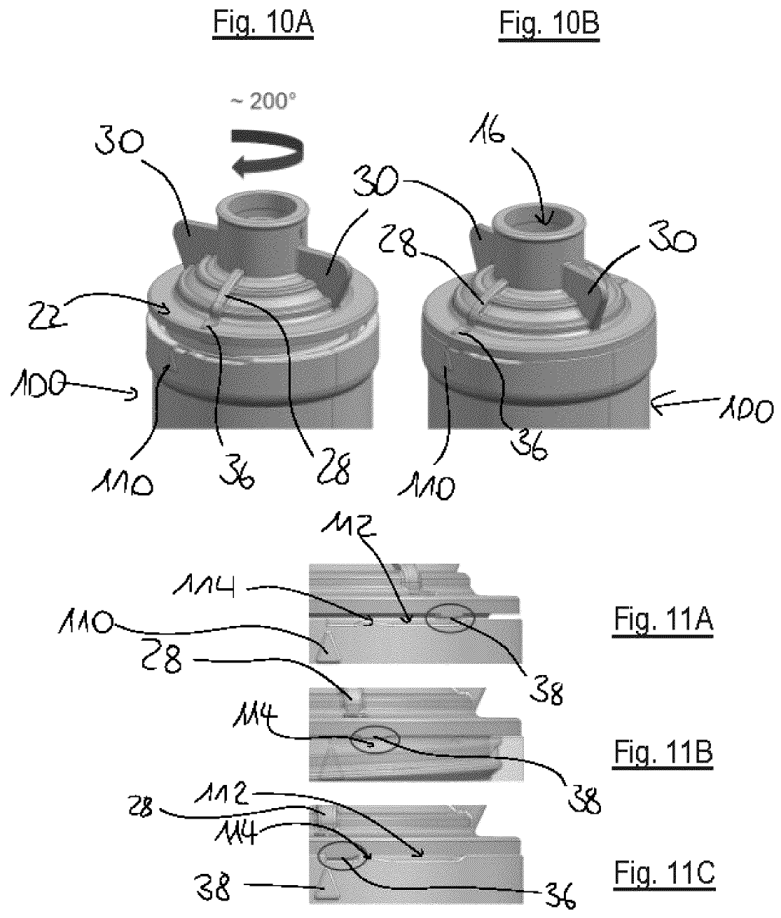

FIGS. 10 and 10B furthermore show that the head part 14 can have at least one alignment element 36 that, in the embodiment shown, is an arrow molded to the web region 22. The support sleeve 100 furthermore has a matching alignment member 110 that is likewise a molded-on arrow in this case. Thus, a user can clearly and unambiguously recognize how the head part 14 should be or become aligned with respect to the support sleeve 100 by aligning the alignment element 36 at the alignment member 110.

It is generally also possible that both the alignment element 36 and the alignment member 110 are of a different design, as long as they enable a simple adjustment of the head part 14 relative to the support sleeve.

Furthermore, it can also be possible that both the head part 14 and the support sleeve 100 have more than one alignment element 36 or alignment member 110 and/or that they are each arranged at a different position at the head part 14 or at the support sleeve.

The matching number or position of the alignment element 36 or the alignment member 110 can therefore vary according to requirements.

Sections are shown in FIGS. 11A-11C that show the connection of the head part 14 to the support sleeve 100. In the embodiment shown, the head part 14 or the support sleeve 100 not only has an alignment element 36 or an alignment member 110 for this purpose, but additionally also has an alignment projection 38 or an alignment recess 112 that are configured to ensure a correct alignment of the head part 14 relative to the support sleeve or to act in a supplementary manner to the alignment element 36 or the alignment member 110.

This means that, to align the head part 14 relative to the support sleeve 100, the alignment projection 38 and alignment recess 112 can be arranged such that the alignment projection 38 can engage into the alignment recess 112.

It is thus generally also possible that only the alignment projection 38 and the alignment recess 112 are provided, i.e. without the alignment element 36 and the alignment member 110. Equally, however, all four components can also be provided for aligning the head part 14 relative to the support sleeve.

Furthermore, provision can also be made that—as shown in FIGS. 11A-11C—the alignment recess 112 additionally has a holding projection 114 that is arranged such that, when correctly aligned, the head part 14 is fixed in the peripheral direction relative to the support sleeve 100.

In FIGS. 11A-11C, it can in turn be clearly recognized that the alignment projection 38 must slide over the holding projection 114 when the head part 14 is connected to the support sleeve 100 in order to finally come to rest behind the holding projection 114 so that the holding projection 114 serves as a fixing that prevents the head part 14 from being easily unscrewed from the support sleeve 100 again. This is then namely only possible by applying a greater force so that the provision of the holding projection 114 can ensure a certain form of fixing.

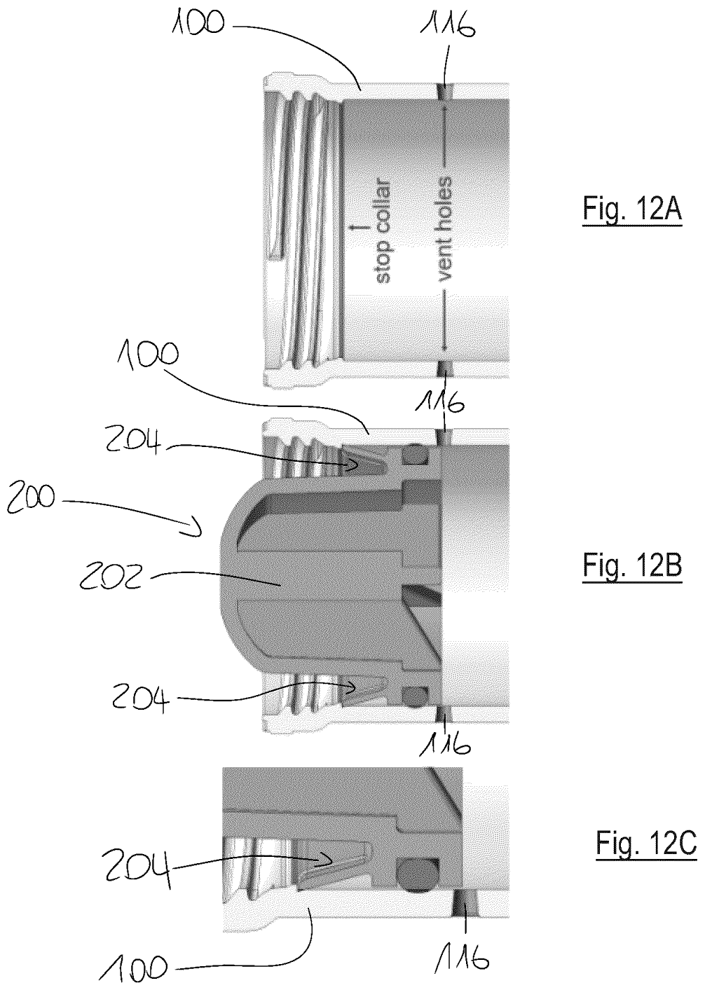

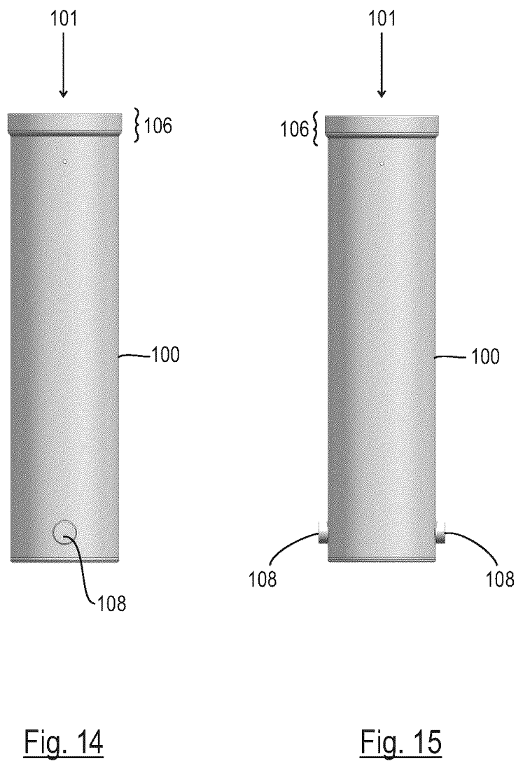

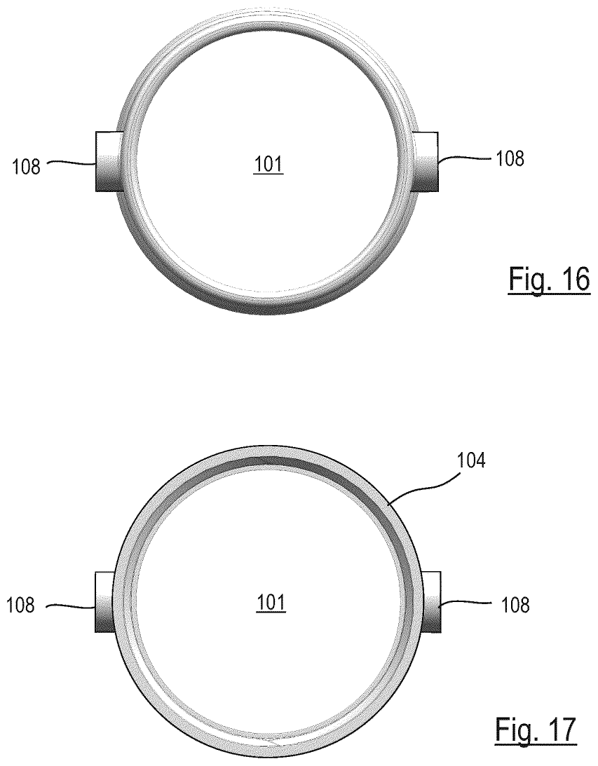

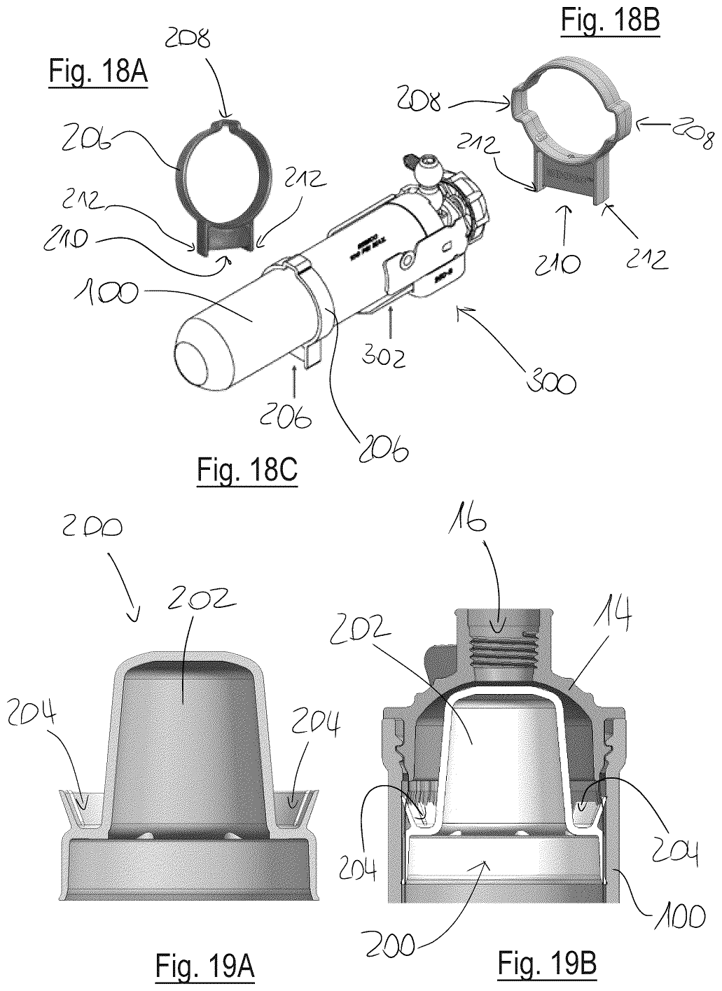

In FIGS. 12A to 19B, a piston 200 is furthermore shown that is configured to dispense the contents of the foil bag 12 from the outlet opening 16 of the head part 14 by pressing against the foil bag 12 from behind along the longitudinal axis M. This usually takes place by a shown dispensing apparatus 300, as is partly shown in FIGS. 18A-18C, for example.

The piston 200 can have a dome-shaped center part 202 and a peripheral-side ring projection 204.

Due to the dome-shaped design of the piston 200, it can, for example, be ensured that almost the entire contents of the foil bag 12 can be emptied. For this purpose, the head part 14 can also be of a matching complementary design so that the center part 202 of the piston 200 can engage into a matching dome-shaped head part 14, wherein the outlet opening 16 is then located in the region of the dome of the head part 14.

The ring projection 204 can serve to catch those parts of the foil bag 12 that have already been emptied so that they cannot get caught between the piston 200 and the support sleeve 100 or alternatively create such folds that the entire contents of the foil bag cannot be emptied.

Furthermore, the ring projection 204 can also be that part of the piston 200 which abuts a stop collar 118 of the support sleeve 100 when the foremost end of the support sleeve 100 is reached (see FIGS. 12A-12C and the description further below).

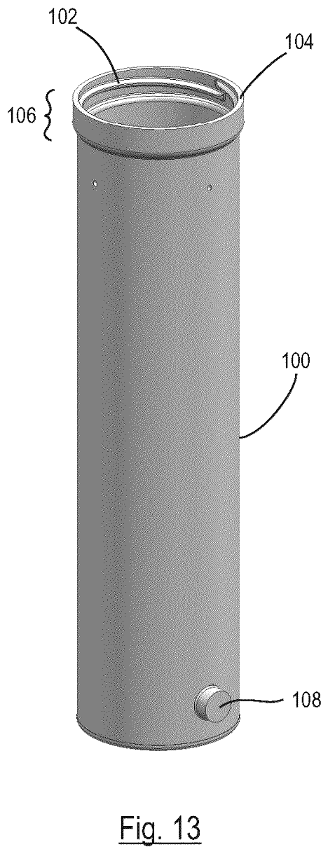

Furthermore, the support sleeve 100, which is shown by way of example in FIGS. 13 to 17, will now be discussed. In the embodiment shown, the support sleeve 100 is formed in one piece, which enables a particularly simple and cost-effective manufacture.

However, it is generally also possible that the support sleeve 100 consists of an inner sleeve and an outer sleeve, for example.

Furthermore, it would also be conceivable for the support sleeve 100 to be composed of a plurality of parts along the center axis M that are releasably connectable to one another via connection points, for example in the form of screw connections, click connections or snap-in connections.

An internal thread 102 is provided in an upper region of the support sleeve 100 and is formed in a complementary manner to the external thread 18 of the foil cartridge 10. This therefore means that the internal thread 102 of the support sleeve 100 is also designed as a multi-start thread, in particular as a two-start thread.

Accordingly, the foil cartridge 10 can be received in a receiving region 101 of the support sleeve 100 and screwed tightly to the internal thread 102 so that the support sleeve 102 surrounds at least the entire foil bag 12 and parts of the head part 14 in a protective manner.

The head part 14 of the foil cartridge at least partly projects from the support sleeve, as can, for example, be easily recognized in the sectional view of FIG. 7 since its web region 22 rests on a front end face 104 of the support sleeve 100.

The front region 106 of the support sleeve can furthermore have a larger diameter than the rest of the support sleeve 100 so that the head part 14 of the foil cartridge 10 fits better therein.

Overall, the foil cartridge 100 is substantially cylindrical so that its diameter hardly changes or does not change at all along the center axis M.

However, it would generally also be possible that the shape of the support sleeve 100 is adapted to the shape of the foil bag 12 and the diameter, for example, tapers slightly downwardly accordingly.

At least one, in particular a plurality of, radial pins 108 are provided at a lower end of the support sleeve 100. They are configured to cooperate with corresponding recesses of a dispensing system (not shown) to thereby fasten the support sleeve 100 together with the foil cartridge 10 to the dispensing system.

As shown in the Figures, the radial pins 108 can, for example, be cylindrical. In other advantageous embodiments, they can also have a mushroom-shaped or round cross-section. The exact shape can be suitably selected depending on the application or the fixing method.

The support sleeve 100 can also have at least one vent hole 116, as can for example be seen in FIGS. 12A-12C, where the support sleeve 100 even has two vent holes 116. The vent holes 116 serve to allow air, which is located between the foil bag 12 and the support sleeve 100, to escape when the piston 200 presses the foil bag 12 to the front in the direction of the head part 14.

Furthermore, the support sleeve 100 can have a stop collar 118 that is arranged in the region of the internal thread 102 and serves as a stop surface for the piston 200. Such a stop collar 18 is, for example, shown in FIGS. 12A-12C.

To use the foil cartridge 10, it is therefore screwed to the support sleeve 100 via its head part 14 so that the foil bag 12 is received in the receiving region 101 of the support sleeve 100. This system is then fixed to a dispensing system (not shown) via the radial pins 108. Known dispensing systems generally comprise a piston 200 (see FIGS. 12A-12C and 19A and 19B) that, when in use, presses against the foil bag 12 from behind to thereby compress it and subsequently empty it.

For this emptying process, a thread 34, to which an outlet nozzle (not shown) can be fastened, can additionally be provided at the front at the outlet opening 16 or at the receiving region 32 of the head part 14.

By providing a thread (external thread 18 or internal thread 102) for fastening the foil cartridge 10 to the support sleeve 100, a simple and quick replacement of an empty foil cartridge 10 can be ensured. Furthermore, it is also possible to replace the foil cartridge 10 without removing the support sleeve 100 from the dispensing system since the foil cartridge 10 can be inserted from the front into the receiving region 101 of the support sleeve.

Furthermore, a protective ring 206 can be provided that can be attached to the support sleeve 100 to prevent an accidental release of a trigger 302 of a dispensing apparatus 300 or to generate a constant release of the trigger 302. For the latter function, the protective ring 206 can have one or more protrusions 208, as will be described in more detail further below.

This can, for example, be advantageous with pneumatic dispensing apparatus 300, as schematically shown in FIGS. 18A-18C. Such dispensing apparatus 300 usually comprise a trigger 302 for triggering a movement of the piston along the longitudinal axis M in the direction of the outlet opening 16 of the foil cartridge 10. The pressure being built up in the pneumatic dispensing apparatus can thereby press the piston 200, which is arranged in the support sleeve 100, against the rear end of the foil cartridge 10 so that the material located in the foil cartridge 10 is dispensed from the outlet opening.

The movement of the piston 200 can, for example, take place by a pneumatic actuation by attaching a compressed air hose (not shown) to the rear end of the dispensing apparatus 300, whereby compressed air can be applied to the piston 200. For this purpose, the compressed air hose is connected to an external pneumatic apparatus (likewise not shown).

To now prevent the trigger 302 from unintentionally triggering a dispensing of the material, the protective ring 206 can be pushed under a lever 304 of the trigger 302. The protective ring 206 can therefore be brought between the lever 306 and the support sleeve 100 to thereby prevent the trigger 302 from triggering the pneumatic apparatus.

However, to ensure a constant dispensing of material by continuously releasing the trigger 302, the protective ring 206 can—as already mentioned above—have one or more protrusions 208 that are configured such that the lever 306 of the trigger 302 can be clamped thereunder to thereby be permanently held in a triggering position.

For this purpose, the protrusions 208 can furthermore have different heights that can correspond to different lever positions. In the above-described pneumatic dispensing apparatus 300, different lever positions can, for example, correspond to different pressures that result in more or less material being dispensed from the foil cartridge 10.

In addition, the protective ring 206 can also have a stabilization projection 210, i.e. a support having one or more supporting legs 212, that is configured such that it can hold the foil cartridge 10 in an at least horizontal position, in particular a slightly inclined position, with respect to a placement surface when the foil cartridge 10 is placed on the placement surface so that the outlet opening 16 is oriented at least horizontally, in particular facing slightly upwards, to prevent material from running out of the foil cartridge 10 when the dispensing apparatus 300 or the foil cartridge 10 is not currently in use.

The protective ring 206 can therefore have up to three different functions: stabilizing the foil cartridge 10 when not in use, constantly releasing the trigger 302 of a dispensing apparatus 300 and/or preventing the release of the trigger 302 of a dispensing apparatus 300.

1. A foil cartridge fillable with at least one fluid, the foil cartridge comprising:
a foil bag as a cartridge shell; and
a rigid head part, the head part comprising an outlet opening configured to empty the fluid of the foil cartridge and an external thread configured to fasten the foil cartridge to a support sleeve, the foil bag fixed to the head part in a region of the external thread.

2. A foil cartridge according to claim 1,
wherein the foil bag is fixed to an outer side of the head part.

3. A foil cartridge according to claim 2,
wherein the foil bag is fastened to the head part such that the foil bag envelops the external thread or contacts the external thread in a form-fitting manner.

4. A foil cartridge according to claim 1,
wherein the foil bag is fixed to an inner side of the head part.

5. A foil cartridge according to claim 1,
wherein the foil bag is adhesively bonded to the head part.

6. A foil cartridge according to claim 1,
wherein the head part is molded to the foil bag.

7-55. (canceled)

56. A foil cartridge according to claim 1,
wherein the head part has a web region arranged in a peripheral direction and extending over a front end of the foil bag facing the head part.

57-72. (canceled)

73. A support sleeve for holding or supporting a foil cartridge according to claim 1,
wherein the support sleeve has an internal thread that corresponds to the external thread of the foil cartridge.

74. A support sleeve according to claim 73,
wherein the support sleeve is formed from metal or from plastic.

75. A support sleeve according to claim 73,
wherein the support sleeve is formed in one piece.

76. A support sleeve according to claim 73,
wherein the support sleeve is formed from multiple parts.

77. A support sleeve according to claim 76,
wherein the support sleeve has at least one connection point configured to connect various parts of the support sleeve to one another.

78. A support sleeve according to claim 77,
wherein the connection point is a thread, a bayonet connection or a click closure.

79-80. (canceled)

81. A support sleeve according to claim 73,
wherein the internal thread is a multi-start thread.

82-101. (canceled)

102. A support sleeve according to claim 74,
wherein the support sleeve is formed from aluminum.

103. A support sleeve according to claim 76,
wherein the support sleeve has a plurality of connection points configured to connect various parts of the support sleeve to one another.
